(19) United States
(12) Patent Application Publication
(10) Pub. No.: US 2024/0187280 A1
(43) Pub. Date: Jun. 6, 2024

(54) TRIGGERING METHOD FOR JOINT CHANNEL ESTIMATION AND USER EQUIPMENT

(71) Applicant: BEIJING XIAOMI MOBILE SOFTWARE CO., LTD., Beijing (CN)

(72) Inventor: Yang LIU, Beijing (CN)

(73) Assignee: BEIJING XIAOMI MOBILE SOFTWARE CO., LTD., Beijing (CN)

(21) Appl. No.: 18/285,250

(22) PCT Filed: Apr. 1, 2021
(86) PCT No.: PCT/CN2021/085117

§ 371 Date: Sep. 30, 2023

(51) Int. Cl. H04L 25/02

(52) U.S. Cl. CPC H04L 25/0204

(57) ABSTRACT

A triggering method for joint channel estimation, in which a use equipment (UE) sends a message related to the joint channel estimation to a network device, so that the network device determines whether to perform the joint channel estimation based on the message; a triggering method for joint channel estimation, in which a network device receives a message related to the joint channel estimation and determines, based on the message, whether to perform the joint channel estimation; a UE, including a processor and a memory.

### CROSS-REFERENCE TO RELATED APPLICATIONS

The present application is a U.S. national phase application of International Application No. PCT/CN2021/085117 filed on Apr. 1, 2021, the entire contents of which are incorporated herein by reference for all purposes.

### TECHNICAL FIELD

The present disclosure relates to the field of mobile communication technology, and in particular, to a triggering method and device for joint channel estimation.

### BACKGROUND

In the current mobile communication system, channel coverage quality and coverage range may be enhanced by joint channel estimation, which however can be realized in the assumption that both a base station and a user equipment meet a certain constraint condition. How to trigger the joint channel estimation when the constraint condition is met is a problem that needs to be solved.

### SUMMARY

A first aspect of the present disclosure provides a triggering method for joint channel estimation, which is applied to a user equipment (UE) and includes: sending a message related to the joint channel estimation to a network device, so that the network device determines whether to perform the joint channel estimation based on the message.

In some embodiments, the UE non-periodically sends the message to the network device to trigger the network device to perform the joint channel estimation when the UE meets a predetermined condition for the joint channel estimation.

In some embodiments, the UE periodically sends the message to the network device.

In some embodiments, the message includes at least one of information indicating whether the UE meets a predetermined condition for the joint channel estimation; and information indicating a time window in which the UE meets the predetermined condition.

In some embodiments, the message is any one of a UE-specific message; a UE group-specific message, where all UEs belonging to a same UE group share the UE group-specific message; and a cell-specific message, where all UEs located within a same cell share the cell-specific message.

In some embodiments, sending the message related to the joint channel estimation to the network device includes: sending the message to the network device in an explicit manner, where the explicit manner includes sending the message via additional dedicated signaling configured for representing the message.

In some embodiments, sending the message related to the joint channel estimation to the network device includes: sending the message to the network device in an explicit manner, where the explicit manner includes sending the message via existing uplink signaling including an additional item configured for representing the message.

In some embodiments, sending the message related to the joint channel estimation to the network device includes: sending the message to the network device in an implicit manner, where the implicit manner includes sending the message by mapping the message to a specified item of specified uplink signaling according to a predetermined operation.

In some embodiments, sending the message related to the joint channel estimation to the network device includes: sending the message to the network device in an implicit manner, where the implicit manner includes sending the message by binding a specific resource block according to a pre-configured mapping relationship.

In some embodiments, sending the message related to the joint channel estimation to the network device includes: sending the message to the network device in an implicit manner, where the implicit manner includes sending the message by multiplexing an existing domain and sending a multiplexing indicator.

A second aspect of the present disclosure provides a triggering method for joint channel estimation, which is applied to a network device and includes: receiving a message related to the joint channel estimation; and determining, based on the message, whether to perform the joint channel estimation.

In some embodiments, determining, based on the message, whether to perform the joint channel estimation includes: performing the joint channel estimation when the message indicates that the UE meets a predetermined condition for the joint channel estimation.

In some embodiments, the message includes at least one of: information indicating whether the UE meets a predetermined condition for the joint channel estimation; and information indicating a time window in which the UE meets the predetermined condition.

In some embodiments, the message is any one of: a UE-specific message; a UE group-specific message, where all UEs belonging to a same UE group share the UE group-specific message; and a cell-specific message, where all UEs located within a same cell share the cell-specific message.

A third aspect of the present disclosure provides a triggering device for joint channel estimation, applied to a user equipment (UE) and includes: a sending module, configured to send a message related to the joint channel estimation to a network device, so that the network device determines whether to perform the joint channel estimation based on the message.

In some embodiments, the sending module non-periodically sends the message to the network device to trigger the network device to perform the joint channel estimation when the UE meets a predetermined condition for the joint channel estimation.

In some embodiments, the sending module periodically sends the message to the network device.

In some embodiments, the message includes at least one of: information indicating whether the UE meets a predetermined condition for the joint channel estimation; and information indicating a time window in which the UE meets the predetermined condition.

In some embodiments, the message is any one of: a UE-specific message; a UE group-specific message, where all UEs belonging to a same UE group share the UE group-specific message; and a cell-specific message, where all UEs located within a same cell share the cell-specific message.

In some embodiments, the sending module sends the message to the network device in an explicit manner, where the explicit manner includes sending the message via additional dedicated signaling configured for representing the message.

In some embodiments, the sending module sends the message to the network device in an explicit manner, where the explicit manner includes sending the message via existing uplink signaling including an additional item configured for representing the message.

In some embodiments, the sending module sends the message to the network device in an implicit manner, where the implicit manner includes sending the message by mapping the message to a specified item of specified uplink signaling according to a predetermined operation.

In some embodiments, the sending module sends the message to the network device in an implicit manner, where the implicit manner includes sending the message by binding a specific resource block according to a pre-configured mapping relationship.

In some embodiments, the sending module sends the message to the network device in an implicit manner, where the implicit manner includes sending the message by multiplexing an existing domain and sending a multiplexing indicator.

A fourth aspect of the present disclosure provides a triggering device for joint channel estimation, which is applied to a network device and includes: a receiving module, configured to receive a message related to the joint channel estimation; and a determining module, configured to determine, based on the message, whether to perform the joint channel estimation.

In some embodiments, the determining module performs the joint channel estimation when the message indicates that the UE meets a predetermined condition for the joint channel estimation.

In some embodiments, the message includes at least one of: information indicating whether the UE meets a predetermined condition for the joint channel estimation; and information indicating a time window in which the UE meets the predetermined condition.

In some embodiments, the message is any one of: a UE-specific message; a UE group-specific message, where all UEs belonging to a same UE group share the UE group-specific message; and a cell-specific message, where all UEs located within a same cell share the cell-specific message.

A fifth aspect of the present disclosure provides a communication device, including a transceiver, a memory and a processor, where the processor is connected to the transceiver and the memory respectively, and configured to, by executing computer-executable instructions on the memory, control sending and receiving wireless signals by the transceiver and implement the triggering method for joint channel estimation according to the embodiment in the first or second aspect.

A sixth aspect of the present disclosure provides a computer storage medium having computer-executable instructions stored thereon that, when being executed by a processor, cause the processor to implement the triggering method for joint channel estimation according to the embodiment in the first or second aspect.

A part of additional aspects and advantages of the present disclosure will be given in the following description, and a part thereof will become apparent from the following description or will be learned through the practice of the present disclosure.

### BRIEF DESCRIPTION OF THE DRAWINGS

The foregoing and/or additional aspects and advantages of the present disclosure will become apparent and readily understood from the following description of embodiments in conjunction with the accompanying drawings, in which:

FIG. 1 is a schematic architecture diagram of a communication system according to an embodiment of the present disclosure;

FIG. 2 is a flow diagram of a triggering method for joint channel estimation according to an embodiment of the present disclosure;

FIG. 3 is a flow diagram of a triggering method for joint channel estimation according to an embodiment of the present disclosure;

FIG. 4 is a flow diagram of a triggering method for joint channel estimation according to an embodiment of the present disclosure;

FIG. 5 is a flow diagram of another triggering method for joint channel estimation according to an embodiment of the present disclosure;

FIG. 6 is a schematic structure diagram of a triggering device for joint channel estimation according to an embodiment of the present disclosure;

FIG. 7 is a schematic structure diagram of a triggering device for joint channel estimation according to an embodiment of the present disclosure;

FIG. 8 is a schematic structure diagram of a communication device according to an embodiment of the present disclosure; and

FIG. 9 is a schematic structure diagram of a chip according to an embodiment of the present disclosure.

### DETAILED DESCRIPTION

Embodiments of the present disclosure are described in detail below, and examples of the embodiments are illustrated in the accompanying drawings, in which the same or similar reference numbers denote the same or similar elements or elements having the same or similar functions throughout. The embodiments described below with reference to the accompanying drawings are exemplary, are intended to explain the present disclosure, and are not to be construed as a limitation of the present disclosure.

For ease of understanding, terms involved in the present disclosure are first introduced.

### 1. Uplink Control Information (UCI)

The UCI is carried by a physical uplink control channel (PUCCH), and the UCI may include uplink resource allocation, hybrid automatic repeat request (HARQ) information, power control, or the like. The PUCCH is a physical channel used to carry uplink scheduling information.

### 2. Msg1/Msg3 Signaling

The Msg1 signaling means sending random access code on physical random access channel (PRACH), and the Msg3 signaling means sending radio resource control (RRC) connection request on physical uplink sharing channel (PUSCH).

### 3. SSB

The SSB represents synchronization signal and physical broadcast channel (PBCH) block, and consists of primary synchronization signal (PSS), secondary synchronization signal (SSS) and PBCH.

In order to better understand a joint channel estimation method disclosed by embodiments of the present disclosure, a communication system to which embodiments of the present disclosure are applied is first described below.

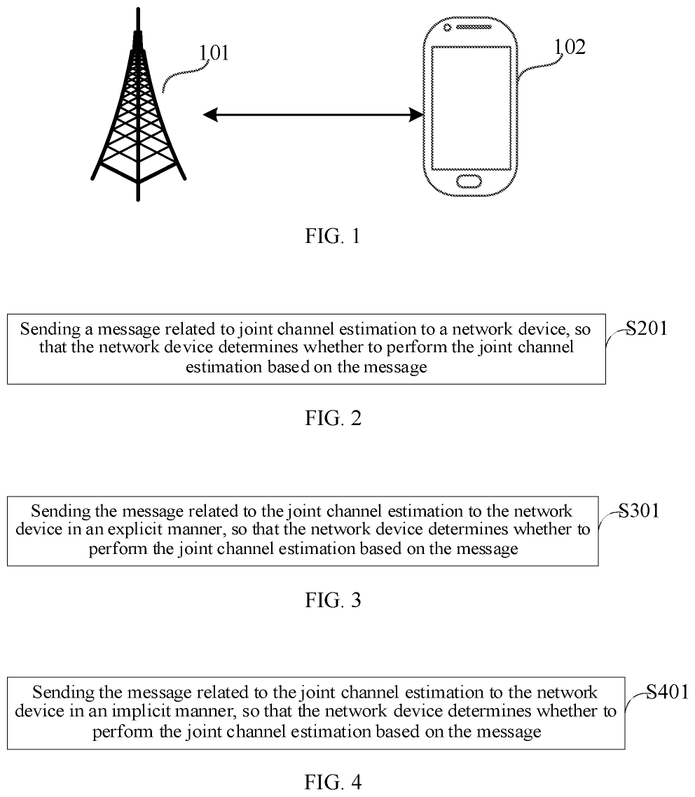

Referring to FIG. 1, FIG. 1 shows a schematic architecture diagram of a communication system according to an embodiment of the present disclosure. The communication system may include, but is not limited to, one network device and one terminal device. The number and form of the devices shown in FIG. 1 are for example only and do not constitute a limitation of the embodiments of the present disclosure, and in practical applications, the communication system may include two or more network devices and two or more user equipments. The communication system shown in FIG. 1 is illustrated as an example including one network device 101 and one user equipment 102.

It should be noted that the technical solutions of the embodiments of the present disclosure can be applied to various communication systems, for example, a long term evolution (LTE) system, a 5th generation (5G) mobile communication system, a 5G new radio (NR) system, or other future new mobile communication systems.

In an embodiment of the present disclosure, the network device 101 is an entity at a network side for transmitting or receiving signals. For example, the network device 101 may be an evolved NodeB (eNB), a transmission reception point (TRP), a next generation NodeB (gNB) in an NR system, a base station in other future mobile communication systems, an access node in a wireless fidelity (WiFi) system or the like. The specific technology and the specific device form for the network device are not limited in the embodiments of the present disclosure. In an embodiment of the present disclosure, the network device may consist of a central unit (CU) and a distributed unit (DU). The CU may also be referred to as a control unit. The structure of CU-DU may divide the protocol layer of the network device such as a base station, to place some of the functions of the protocol layer in the CU for central control and to distribute the remaining part or all of the functions of the protocol layer in the DU so that the CU control the DU centrally.

In an embodiment of the present disclosure, the user equipment 102 is an entity such as a mobile phone at a user side for receiving or transmitting signals. The user equipment (UE) may also be referred to as terminal, mobile station (MS), mobile terminal (MT), and the like. The user equipment may be a car with communication function, intelligent car, mobile phone, wearable device, tablet computers (Pad), computer with wireless transceiving function, virtual reality (VR) terminal device, augmented reality (AR) terminal device, wireless terminal device in industrial control, wireless terminal device in self-driving, wireless terminal device in remote medical surgery, wireless terminal device in smart grid, wireless terminal device in transportation safety, wireless terminal device in smart city, wireless terminal device in smart home, and the like. The specific technology and the specific device form for the user equipment are not limited in the embodiments of the present disclosure.

It is to understood that the communication system described in the embodiments of the present disclosure is intended to more clearly illustrate the technical solutions of the embodiments of the present disclosure, and does not constitute a limitation on the technical solutions provided by the embodiments of the present disclosure, and those skilled in the art may know that, with the evolution of the system architecture and the emergence of new business scenarios, the technical solutions provided by the embodiments of the present disclosure are equally applicable to similar technical problems.

In the mobile communication system, channel coverage quality and coverage range may be enhanced by joint channel estimation. In order to realize the joint channel estimation, the user equipment needs to meet a certain constraint condition. How to trigger the joint channel estimation when the constraint condition is met is a problem that needs to be solved.

A triggering method for joint channel estimation and device thereof provided by the present disclosure are described in detail below in conjunction with the accompanying drawings.

FIG. 2 is a flow diagram of a triggering method for joint channel estimation according to an embodiment of the present disclosure. As shown in FIG. 2, the method may be applied to a UE, and may include, but is not limited to:

step S201, sending a message related to joint channel estimation to a network device, so that the network device determines whether to perform the joint channel estimation based on the message.

In an embodiment, the UE sends the message related to the joint channel estimation to the network device, for example, the UE may send the message related to the joint channel estimation to the network device based on a state of the UE itself, e.g., whether the UE currently meets a predetermined condition related to the joint channel estimation. For example, the UE may send the message periodically, in which case the message serves as a reporting message to report the state regarding whether the UE meets the predetermined condition to the network device to assist the network device in determining whether to perform the joint channel estimation. For another example, the UE may send the message non-periodically when the UE currently meets the predetermined condition related to the joint channel estimation, for example, only when the UE currently meets the predetermined condition related to the joint channel estimation, in which case the message serves as a trigger message to trigger the network device to perform the joint channel estimation.

The predetermined condition related to the joint channel estimation may include, but is not limited to, that modulation order remains unchanged, resource block (RB) allocation remains unchanged (i.e., there is no intra- and inter-slot frequency hopping), transmission power level remains unchanged, and there is no beam switching and antenna switching.

It may determine, based on the message, whether to perform the joint channel estimation. For example, if the message indicates that the UE currently meets the predetermined condition related to the joint channel estimation, the joint channel estimation is performed. For another example, if the message indicates that the UE does not currently meet the predetermined condition related to the joint channel estimation, it determines not to perform the joint channel estimation.

In some embodiments, the message may include at least one of: information indicating whether the UE meets a predetermined condition for the joint channel estimation; and information indicating a time window in which the UE meets the predetermined condition.

For example, the message may be represented by one bit, and the one bit indicates whether the UE currently meets the predetermined condition related to the joint channel estimation. For example, when the bit has a value of “1”, it indicates that the UE currently meets the predetermined condition related to the joint channel estimation, and when the bit has a value of “0”, it indicates that the UE currently does not meet the predetermined conditions related to the joint channel estimation.

For another example, the message may be represented by a plurality of bits, and the plurality of bits indicate a time window in which the UE currently meets the predetermined condition related to the joint channel estimation, which implies that the UE currently meets the predetermined condition related to the joint channel estimation. For example, the plurality of bits may indicate a duration, a start time, an end time or the like of the time window. The time window may be in a unit of time slot, sub-time slot, number of repetitions. For example, if the plurality of bits indicates five time slots, it indicates that the UE meets the predetermined condition within the five time slots from the current moment. In some embodiments, if the plurality of bits indicates a start time slot 1 and an end time slot 5, it indicates that the UE meets the predetermined condition from the time slot 1 to the time slot 5.

For another example, the message may be represented by a single bit indicating whether the UE currently meets the predetermined condition related to the joint channel estimation and a plurality of bits indicating a time window in which the UE currently meets the predetermined condition related to the joint channel estimation.

In some embodiments, the message may be a UE-specific message, i.e., each UE may send the message individually.

In some embodiments, the message may be a UE group-specific message, where all UEs belonging to the same UE group share the UE group-specific message, i.e., a plurality of UEs belonging to the same UE group may multiplex the same message.

In some embodiments, the message may be a cell-specific message, where all UEs located within the same cell share the cell-specific message, i.e., a plurality of UEs located within the same cell may multiplex the same message.

For example, a plurality of UEs belonging to the same UE group or located within the same cell may determine a common message according to a preset rule, and a certain UE sends the common message to the network device. If the time windows in which the plurality of UEs meet the predetermined condition related to the joint channel estimation are inconsistent, the smallest time window may be taken to send the message. For example, if UE1 to UE3 multiplex the common message, the time window in which UE1 meets the predetermined condition is time slot 1 to time slot 5, the time window in which UE2 meets the predetermined condition is time slot 1 to time slot 4, the time window in which UE3 meets the predetermined condition is time slot 2 to time slot 6, then it may determine the common message indicating the time window for time slot 2-time slot 4, and the common message may then be sent to the network device by any one of the UEs1 to UE3. As a plurality of UEs multiplex the same message, signaling overhead can be reduced.

By implementing the embodiments of the present disclosure, a user equipment may send a message related to joint channel estimation to a network device so that the network device determines whether to perform the joint channel estimation, the UE may non-periodically send the message to the network device when the state of the UE itself meets the predetermined condition to trigger the network device to perform the joint channel estimation or may periodically send the message to the network device to assist the network device in determining whether to perform the joint channel estimation, which avoids a situation in which the UE does not meet a constraint condition when the joint channel estimation is triggered by the network device.

FIG. 3 illustrates a flow diagram of a triggering method for joint channel estimation according to an embodiment of the present disclosure. As shown in FIG. 3, the method may be applied to a UE, and may include, but is not limited to:

step S301, sending a message related to joint channel estimation to a network device in an explicit manner, so that the network device determines whether to perform the joint channel estimation based on the message.

In an embodiment, the UE may send the message related to the joint channel estimation to the network device in an explicit manner, e.g., the UE may send the message related to the joint channel estimation to the network device in an explicit manner according to a state of the UE itself, e.g., whether or not the UE currently meets a predetermined condition related to the joint channel estimation. The explicit manner may include, but is not limited to, sending the message via additional dedicated signaling configured for representing the message, for example, configured for only representing the message, and sending the message via existing uplink signaling including an additional item configured for representing the message, for example, configured for only representing the message. In some embodiments, the UE may periodically send the message, in which case the message serves as a reporting message to report the state of whether the UE meets the predetermined condition to the network device to assist the network device in determining whether to perform the joint channel estimation. In some other embodiments, the UE may non-periodically send the message when the UE currently meets the predetermined condition related to the joint channel estimation, for example, only when the UE currently meets the predetermined condition related to the joint channel estimation, in which case the message serves as a trigger message to trigger the network device to perform the joint channel estimation.

In some embodiments, the explicit manner may include sending the message via additional dedicated signaling configured for representing the message, for example, configured for only representing the message.

For example, the UE may send the message as UE capability reporting information to the network device, and the additional UE capability reporting information is dedicated for sending the message.

For another example, the UE may send the message as additional auxiliary reporting information to the network device, and the additional auxiliary information is dedicated for sending the message.

In some embodiments, the explicit manner may include sending the message via existing uplink signaling including an additional item configured for representing the message, for example, configured for only representing the message.

For example, the UE may add the additional item to the existing uplink signaling to send the message, e.g., add an additional field to an uplink signaling to represent the message.

In some embodiments, the existing uplink signaling may include one of UCI, radio resource control (RRC) message, media access control control element (MAC-CE) message, Msg1 signaling, and Msg3 signaling.

For example, the UE may add an additional field or symbol to the UCI to represent the message.

It may determine, based on the message, whether to perform the joint channel estimation. For example, if the message indicates that the UE currently meets the predetermined condition related to the joint channel estimation, the joint channel estimation is performed. For another example, if the message indicates that the UE does not currently meet the predetermined condition related to the joint channel estimation, it determines not to perform the joint channel estimation.

In some embodiments, the message may include at least one of: information indicating whether the UE meets a predetermined condition for the joint channel estimation; and information indicating a time window in which the UE meets the predetermined condition.

For example, the message may be represented by only one bit, and the one bit indicates whether the UE currently meets the predetermined condition related to the joint channel estimation.

For another example, the message may be represented by a plurality of bits, and the plurality of bits indicate a time window in which the UE currently meets the predetermined condition related to the joint channel estimation, which implies that the UE currently meets the predetermined condition related to the joint channel estimation.

For another example, the message may be represented by one bit indicating whether the UE currently meets the predetermined condition related to the joint channel estimation and a plurality of bits indicating a time window in which the UE currently meets the predetermined condition related to the joint channel estimation.

In some embodiments, the message may be a UE-specific message, i.e., each UE may send the message individually.

In some embodiments, the message may be a UE group-specific message, where all UEs belonging to the same UE group share the UE group-specific message, i.e., a plurality of UEs belonging to the same UE group may multiplex the same message.

In some embodiments, the message may be a cell-specific message, where all UEs located within the same cell share the cell-specific message, i.e., a plurality of UEs located within the same cell may multiplex the same message.

For example, a plurality of UEs belonging to the same UE group or located within the same cell may determine a common message according to a preset rule, and a certain UE sends the common message to the network device. If the time windows in which the plurality of UEs meet the predetermined condition related to the joint channel estimation are inconsistent, the smallest time window may be taken to send the message. As a plurality of UEs multiplex the same message, signaling overhead can be reduced.

By implementing the embodiments of the present disclosure, a user equipment may send a message related to joint channel estimation to a network device in an explicit manner so that the network device can directly obtains the message and thus can determine whether to perform the joint channel estimation according to the message.

FIG. 4 illustrates a flow diagram of a triggering method for joint channel estimation according to an embodiment of the present disclosure. As shown in FIG. 4, the method may be applied to a UE, and may include, but is not limited to:

step S401, sending a message related to joint channel estimation to a network device in an implicit manner, so that the network device determines whether to perform the joint channel estimation based on the message.

In an embodiment, the UE may send the message related to the joint channel estimation to the network device in an implicit manner, e.g., the UE may send the message related to the joint channel estimation to the network device in an implicit manner according to a state of the UE itself, e.g., whether or not the UE currently meets a predetermined condition related to the joint channel estimation. The implicit manner may include, but is not limited to, sending the message by mapping the message to a specified item of specified uplink signaling according to a predetermined operation, sending the message by multiplexing an existing message domain and sending a multiplexing indicator, and sending the message by binding a specific resource block according to a pre-configured mapping relationship. In some embodiments, the UE may periodically send the message, in which case the message serves as a reporting message to report the state of whether the UE meets the predetermined condition to the network device to assist the network device in determining whether to perform the joint channel estimation. In some other embodiments, the UE may non-periodically send the message when the UE currently meets the predetermined condition related to the joint channel estimation, for example, only when the UE currently meets the predetermined condition related to the joint channel estimation, in which case the message serves as a trigger message to trigger the network device to perform the joint channel estimation.

In some embodiments, the implicit manner may include sending the message by mapping the message to a specified item of specified uplink signaling according to a predetermined operation.

For example, the UE may map the message to the specified item of the specified uplink signaling according to the predetermined operation, and send the specified uplink signaling to the network device, which, upon receiving the specified uplink signaling, obtains the message by parsing the specified item according to the predetermined operation.

In some embodiments, the specified uplink signaling may include one of uplink control information (UCI), RRC message, MAC-CE message, Msg1 signaling, and Msg3 signaling.

For example, the UE may map the message to a specified field of UCI by means of an AND operation, and the network device, upon receiving the UCI, may parse the specified field to obtain the message. For example, the information of whether the constraint condition is met is mapped into the highest bit of the Scheduling Request (SR) message, if the SR value is “1”, it means that the current UE meets the predetermined condition related to the joint channel estimation. Then, the network device, upon receiving the UCI, may obtain the message according to the default value of the specified field.

In some embodiments, the implicit manner may include sending the message by binding a specific resource block according to a pre-configured mapping relationship.

For example, the UE may send the message by binding the specific resource block according to the pre-configured mapping relationship. The pre-configured mapping relationship may indicate a correspondence between the bound resource block and the message. For example, for resource blocks 1 to N, the pre-configured mapping relationship may indicate that when the first N/2 resource blocks are bound, the corresponding message indicates that the predetermined condition related to the joint channel estimation is met; and when the last N/2 resource blocks are bound, the corresponding message indicates that the predetermined condition related to the joint channel estimation is not met.

In some embodiments, the resource block may be a resource block of any of a physical uplink control channel (PUCCH) resource, a physical random access channel (PRACH) resource, and a PRACH preamble.

For example, for the PUCCH resource, the UE may specify one resource block in the PUCCH resource, and when the bound PUCCH resource includes the specified resource block, the corresponding message indicates that the predetermined condition related to the joint channel estimation is met, and when the bound PUCCH resource does not include the specified resource block, the corresponding message indicates that the predetermined condition related to the joint channel estimation is not met. In some embodiments, the UE may specify two resource blocks in the PUCCH resource, and when the bound PUCCH resource includes the first specified resource block, the corresponding message indicates that the predetermined condition related to the joint channel estimation is met, and when the bound PUCCH resource includes the second specified resource block, the corresponding message indicates that the predetermined condition related to the joint channel estimation is not met.

For another example, for the PRACH resource, the UE may specify one resource block in the PRACH resource, and when the bound PRACH resource includes the specified resource block, the corresponding message indicates that the predetermined condition related to the joint channel estimation is met, and when the bound PRACH resource does not include the specified resource block, the corresponding message indicates that the predetermined condition related to the joint channel estimation is not met. In some embodiments, the UE may specify two resource blocks in the PRACH resource, and when the bound PRACH resource includes the first specified resource block, the corresponding message indicates that the predetermined condition related to the joint channel estimation is met, and when the bound PRACH resource includes the second specified resource block, the corresponding message indicates that the predetermined condition related to the joint channel estimation is not met.

For another example, for the PRACH preamble, the UE may specify that when a certain portion of the PRACH preamble is used, the corresponding message indicates that the predetermined condition related to the joint channel estimation is met, and when another portion of the PRACH preamble is used, the corresponding message indicates that the predetermined condition related to the joint channel estimation is not met.

In some embodiments, the implicit manner may include sending the message by multiplexing an existing domain and sending a multiplexing indicator.

For example, the UE may multiplex a PRI (PUCCH resource indicator) domain in DCI, i.e., it may write the message related to the joint channel estimation into the PRI domain and notify, via the multiplexing indicator, that the PRI domain has been multiplexed, such that the network device may obtain the message related to the joint channel estimation from that PRI domain.

For another example, the UE may multiplex a power control domain, i.e., it may write the message related to the joint channel estimation into the power control domain and notify, via the multiplexing indicator, that the power control domain has been multiplexed, such that the network device may obtain the message related to the joint channel estimation from the power control domain.

It may determine, based on the message, whether to perform the joint channel estimation. For example, if the message indicates that the UE currently meets the predetermined condition related to the joint channel estimation, the joint channel estimation is performed. For another example, if the message indicates that the UE does not currently meet the predetermined condition related to the joint channel estimation, it determines not to perform the joint channel estimation.

In some embodiments, the message may include at least one of: information indicating whether the UE meets a predetermined condition for the joint channel estimation; and information indicating a time window in which the UE meets the predetermined condition.

For example, the message may be represented by only one bit, and the one bit indicates whether the UE currently meets the predetermined condition related to the joint channel estimation.

For another example, the message may be represented by a plurality of bits, and the plurality of bits indicate a time window in which the UE currently meets the predetermined condition related to the joint channel estimation, which implies that the UE currently meets the predetermined condition related to the joint channel estimation.

For another example, the message may be represented by one bit indicating whether the UE currently meets the predetermined condition related to the joint channel estimation and a plurality of bits indicating a time window in which the UE currently meets the predetermined condition related to the joint channel estimation.

In some embodiments, the message may be a UE-specific message, i.e., each UE may send the message individually.

In some embodiments, the message may be a UE group-specific message, where all UEs belonging to the same UE group share the UE group-specific message, i.e., a plurality of UEs belonging to the same UE group may multiplex the same message.

In some embodiments, the message may be a cell-specific message, where all UEs located within the same cell share the cell-specific message, i.e., a plurality of UEs located within the same cell may multiplex the same message.

For example, a plurality of UEs belonging to the same UE group or located within the same cell may determine a common message according to a preset rule, and a certain UE sends the common message to the network device. If the time windows in which the plurality of UEs meet the predetermined condition related to the joint channel estimation are inconsistent, the smallest time window may be taken to send the message. As a plurality of UEs multiplex the same message, signaling overhead can be reduced.

By implementing the embodiments of the present disclosure, a user equipment may send a message related to joint channel estimation to a network device in an implicit manner, so that the user equipment does not need to add additional signaling or item to send the message, which saves signaling overhead.

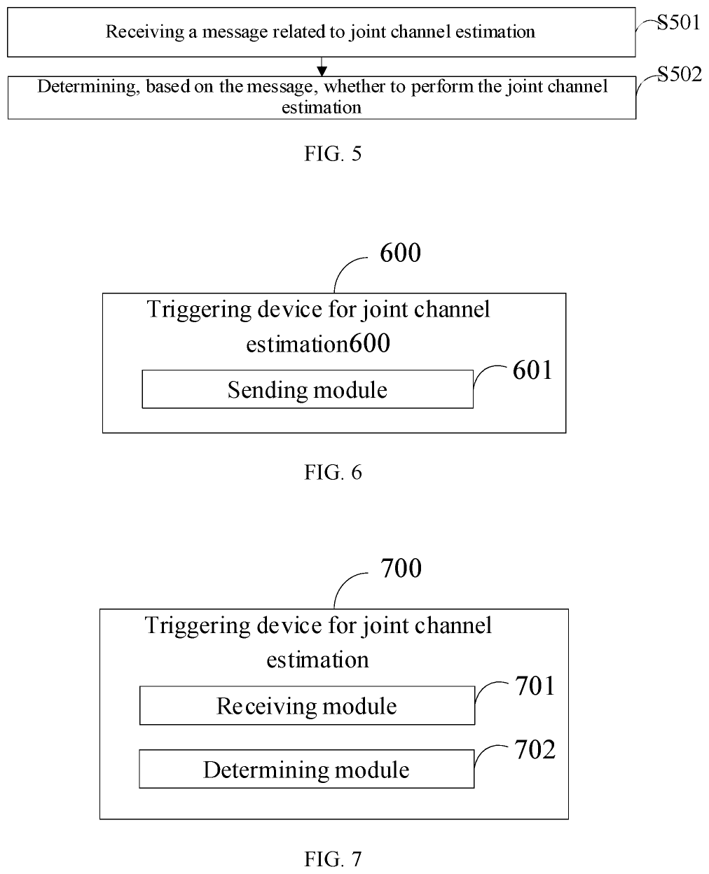

FIG. 5 is a flow diagram of a triggering method for joint channel estimation according to an embodiment of the present disclosure. As shown in FIG. 5, the method may be applied to a network device, and may include, but is not limited to, the following steps S501 and S502.

In step S501, a message related to joint channel estimation is received.

In an embodiment, the network device may receive the message related to the joint channel estimation sent from a UE. The UE may send the message related to the joint channel estimation to the network device based on a state of the UE itself, e.g., whether the UE currently meets a predetermined condition related to the joint channel estimation. For example, the UE may send the message periodically, in which case the message serves as a reporting message to report the state regarding whether the UE meets the predetermined condition to the network device to assist the network device in determining whether to perform the joint channel estimation. For another example, the UE may send the message non-periodically when the UE currently meets the predetermined condition related to the joint channel estimation, only when the UE currently meets the predetermined condition related to the joint channel estimation, in which case the message serves as a trigger message to trigger the network device to perform the joint channel estimation.

The predetermined condition related to the joint channel estimation may include, but is not limited to, that modulation order remains unchanged, resource block (RB) allocation remains unchanged (i.e., there is no intra- and inter-slot frequency hopping), transmission power level remains unchanged, and there is no beam switching and antenna switching.

In step S502, it determines whether to perform the joint channel estimation based on the message.

It may determine, based on the message, whether to perform the joint channel estimation. For example, if the message indicates that the UE currently meets the predetermined condition related to the joint channel estimation, the joint channel estimation is performed. For another example, if the message indicates that the UE does not currently meet the predetermined condition related to the joint channel estimation, it determines not to perform the joint channel estimation.

In some embodiments, the message may include at least one of: information indicating whether the UE meets a predetermined condition for the joint channel estimation; and information indicating a time window in which the UE meets the predetermined condition.

For example, the message may be represented by only one bit, and the one bit indicates whether the UE currently meets the predetermined condition related to the joint channel estimation. For example, when the bit has a value of “1”, it indicates that the UE currently meets the predetermined condition related to the joint channel estimation, and when the bit has a value of “0”, it indicates that the UE currently does not meet the predetermined conditions related to the joint channel estimation.

For another example, the message may be represented by a plurality of bits, and the plurality of bits indicate a time window in which the UE currently meets the predetermined condition related to the joint channel estimation, which implies that the UE currently meets the predetermined condition related to the joint channel estimation. For example, the plurality of bits may indicate a duration, a start time, an end time or the like of the time window. The time window may be in a unit of time slot, sub-time slot, number of repetitions. For example, if the plurality of bits indicates five time slots, it indicates that the UE meets the predetermined condition within the five time slots from the current moment. In some embodiments, if the plurality of bits indicates a start time slot 1 and an end time slot 5, it indicates that the UE meets the predetermined condition from the time slot 1 to the time slot 5.

For another example, the message may be represented by one bit indicating whether the UE currently meets the predetermined condition related to the joint channel estimation and a plurality of bits indicating a time window in which the UE currently meets the predetermined condition related to the joint channel estimation.

In some embodiments, the message may be a UE-specific message, i.e., each UE may send the message individually.

In some embodiments, the message may be a UE group-specific message, where all UEs belonging to the same UE group share the UE group-specific message, i.e., a plurality of UEs belonging to the same UE group may multiplex the same message.

In some embodiments, the message may be a cell-specific message, where all UEs located within the same cell share the cell-specific message, i.e., a plurality of UEs located within the same cell may multiplex the same message.

For example, a plurality of UEs belonging to the same UE group or located within the same cell may determine a common message according to a preset rule, and a certain UE sends the common message to the network device. If the time windows in which the plurality of UEs meet the predetermined condition related to the joint channel estimation are inconsistent, the smallest time window may be taken to send the message. For example, if UE1 to UE3 multiplex the common message, the time window in which UE1 meets the predetermined condition is time slot 1 to time slot 5, the time window in which UE2 meets the predetermined condition is time slot 1 to time slot 4, the time window in which UE3 meets the predetermined condition is time slot 2 to time slot 6, then it may determine the common message indicating the time window for time slot 2-time slot 4, and the common message may then be sent to the network device by any one of the UEs1 to UE3. As a plurality of UEs multiplex the same message, signaling overhead can be reduced.

By implementing the embodiments of the present disclosure, a network device may receive a message related to joint channel estimation, and determine whether to perform the joint channel estimation based on this message. As the UE may non-periodically send the message to the network device when the state of the UE itself meets the predetermined condition to trigger the network device to perform the joint channel estimation or may periodically send the message to the network device to assist the network device in determining whether to perform the joint channel estimation, which avoids a situation in which the UE does not meet a constraint condition when the joint channel estimation is triggered by the network device.

In the above-described embodiments of the present disclosure, the methods provided in the embodiments of the present disclosure are described from the perspectives of a network device and a user equipment, respectively. In order to implement each of the above-described functions in the method provided by the embodiments of the present disclosure, the network device and the user equipment may include a hardware structure and a software module, and implement each of the above-described functions in the form of a hardware structure, a software module, or a combination form of a hardware structure and a software module. Each of the above-described functions may be performed in a hardware structure, a software module, or a combination form of a hardware structure and a software module.

Corresponding to the triggering method for joint channel estimation provided by the above several embodiments, the present disclosure also provides a triggering device for joint channel estimation. Since the triggering device for joint channel estimation provided by the embodiment of the present disclosure corresponds to the triggering method for joint channel estimation provided by the above several embodiments, the way of implementing the triggering method for joint channel estimation is also applicable to the triggering device for joint channel estimation provided by the embodiment, which thus is not repeated in the embodiment. FIG. 6 to FIG. 7 are schematic structure diagrams of triggering devices for joint channel estimation according to the present disclosure.

FIG. 6 is a schematic structure diagram of a triggering device for joint channel estimation 600 according to an embodiment of the present disclosure. The triggering device for joint channel estimation 600 may be applied to a UE.

As shown in FIG. 6, the triggering device for joint channel estimation 600 includes a sending module 601 configured to send a message related to the joint channel estimation to a network device, so that the network device determines whether to perform the joint channel estimation based on the message.

By implementing the embodiment of the present disclosure, a user equipment may send a message related to joint channel estimation to a network device so that the network device determines whether to perform the joint channel estimation, the UE may non-periodically send the message to the network device when the state of the UE itself meets the predetermined condition to trigger the network device to perform the joint channel estimation or may periodically send the message to the network device to assist the network device in determining whether to perform the joint channel estimation, which avoids a situation in which the UE does not meet a constraint condition when the joint channel estimation is triggered by the network device.

In some embodiments, the message includes at least one of: information indicating whether the UE meets a predetermined condition for the joint channel estimation; and information indicating a time window in which the UE meets the predetermined condition.

In some embodiments, the message is any one of: a UE-specific message; a UE group-specific message, where all UEs belonging to a same UE group share the UE group-specific message; and a cell-specific message, where all UEs located within a same cell share the cell-specific message.

In some embodiments, the sending module 601 sends the message to the network device in an explicit manner, where the explicit manner includes sending the message via additional dedicated signaling configured for representing the message, for example, configured for only representing the message.

In some embodiments, the sending module 601 sends the message to the network device in an explicit manner, where the explicit manner includes sending the message via existing uplink signaling including an additional item configured for representing the message, for example, configured for only representing the message.

In some embodiments, the sending module 601 sends the message to the network device in an implicit manner, where the implicit manner includes sending the message by mapping the message to a specified item of specified uplink signaling according to a predetermined operation or by binding a specific resource block according to a pre-configured mapping relationship.

In some embodiments, the sending module 601 sends the message to the network device in an implicit manner, where the implicit manner includes sending the message by mapping the message according to a predetermined operation

In some embodiments, the sending module 601 sends the message to the network device in an implicit manner, where the implicit manner includes sending the message by binding a specific resource block according to a pre-configured mapping relationship.

In some embodiments, the sending module 601 sends the message to the network device in an implicit manner, where the implicit manner includes sending the message by multiplexing an existing domain and sending a multiplexing indicator.

FIG. 7 is a schematic structure diagram of a triggering device for joint channel estimation 700 according to an embodiment of the present disclosure. The triggering device for joint channel estimation 700 may be applied to a network device.

As shown in FIG. 7, the triggering device for joint channel estimation 700 includes: a receiving module 701, configured to receive a message related to the joint channel estimation; and a determining module 702, configured to determine, based on the message, whether to perform the joint channel estimation.

By implementing the embodiment of the present disclosure, a network device may receive a message related to joint channel estimation, and determine whether to perform the joint channel estimation based on this message. As the UE may non-periodically send the message to the network device when the state of the UE itself meets the predetermined condition to trigger the network device to perform the joint channel estimation or may periodically send the message to the network device to assist the network device in determining whether to perform the joint channel estimation, which avoids a situation in which the UE does not meet a constraint condition when the joint channel estimation is triggered by the network device.

In some embodiments, the determining module 702 performs the joint channel estimation when the message indicates that the UE meets a predetermined condition for the joint channel estimation.

In some embodiments, the message includes at least one of: information indicating whether the UE meets a predetermined condition for the joint channel estimation; and information indicating a time window in which the UE meets the predetermined condition.

In some embodiments, the message is any one of: a UE-specific message; a UE group-specific message, where all UEs belonging to a same UE group share the UE group-specific message; and a cell-specific message, where all UEs located within a same cell share the cell-specific message.

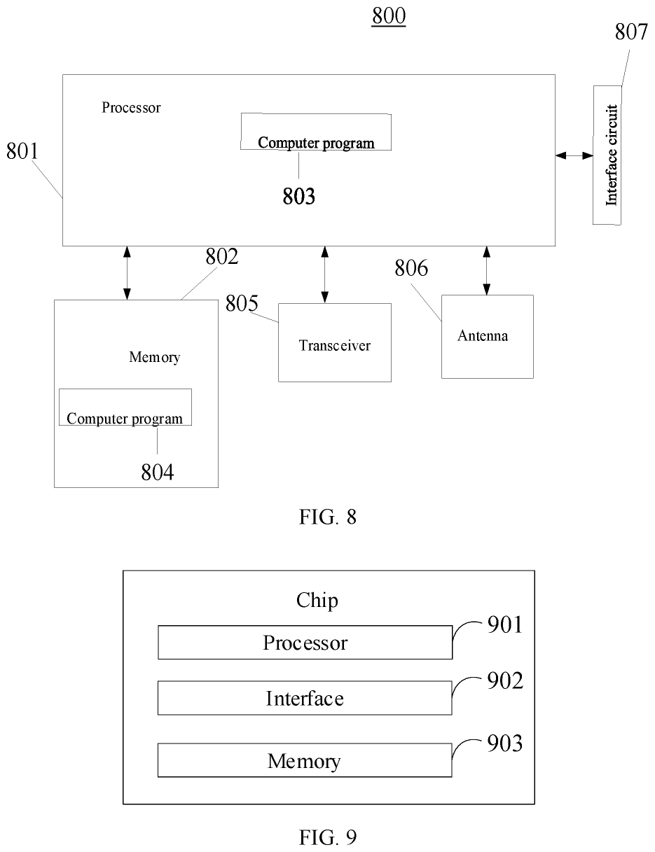

Referring to FIG. 8, FIG. 8 is a schematic structure diagram of the of another communication device 800 according to an embodiment of the present disclosure. The communication device 800 may be a network device or a user equipment, and may also be a chip, chip system, or processor and the like, which supports a network device to implement the above-described method. The device may be used to implement the method described in the above method embodiments, details of which may refer to the above description in the above method embodiments.

The communication device 800 may include one or more processors 801. The processor 801 may be a general-purpose processor, a dedicated processor or the like. For example, the processor 801 may be a baseband processor or a central processor. The baseband processor may process communication protocols and communication data, and the central processor may control a communication device (e.g., a base station, baseband chip, terminal device, terminal device chip, DU or CU, etc.), execute a computer program, and process data of the computer program.

Alternatively, the communication device 800 may further include one or more memories 802 which may have a computer program 804 stored thereon, and the processor 801 executes the computer program 804 to cause the communication device 800 to perform the method described in the above method embodiments. Alternatively, the memory 802 may further store data. The communication device 800 and the memory 802 may be provided separately or may be integrated together.

Alternatively, the communication device 800 may further include a transceiver 805 and an antenna 806. The transceiver 805 may be referred to as a transceiver unit, a transceiver machine, a transceiver circuit or the like, and is configured to implement a transceiver function. The transceiver 805 may include a receiver and a transmitter, the receiver may be referred to as a receiving machine, a receiving circuit or the like, and is configured to implement a receiving function, and the transmitter may be referred to as a transmitting machine, a transmitting circuit or the like, and is configured to implement a transmitting function.

Alternatively, the communication device 800 may further include one or more interface circuits 807. The interface circuit 807 is configured to receive code instructions and transmit the same to the processor 801. The processor 801 runs the code instructions to cause the communication device 800 to perform the method described in the above method embodiments.

The communication device 800 is a user equipment, and the processor 801 is configured to instruct the transceiver 805 to perform step S201 in FIG. 2, step S301 in FIG. 3, and step S401 in FIG. 4.

The communication device 800 is a network device, the transceiver 805 is configured to perform step S501 in FIG. 5, and the processor 801 is configured to perform step S502 in FIG. 5.

In an implementation, the processor 801 may include a transceiver for implementing receiving and transmitting functions. The transceiver may for example be a transceiver circuit, or an interface, or an interface circuit. The transceiver circuitry, interface, or interface circuitry for implementing the receiving and transmitting functions may be separate or may be integrated together. The transceiver circuit, interface, or interface circuit described above may be used for code/data reading and writing. In some embodiments, the transceiver circuit, interface, or interface circuit described above may be used for signal transmission or delivery.

In an implementation, the processor 801 may store a computer program 803, which runs on the processor 801 to cause the communication device 800 to perform the method described in the method embodiments described above. The computer program 803 may be solidified in the processor 801, in which case the processor 801 may be implemented by hardware.

In an implementation, the communication device 800 may include a circuit, the circuit may implement the transmitting or receiving or communicating function in the above method embodiments. The processor and transceiver described in the present disclosure may be implemented in an integrated circuit (IC), analogue IC, radio frequency integrated circuit (RFIC), mixed signal IC, application specific integrated circuit (ASIC), printed circuit board (PCB), electronic device or the like. The processor and transceiver may also be manufactured using various IC process technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs).

The communication device described in the above embodiments may be a network device or a terminal device (such as the first terminal device in the method embodiments described above), but the scope of the communication device described in the present disclosure is not limited thereto, and the structure of the communication device may not be limited by FIG. 8. The communication device may be a stand-alone device or may be part of a large device. For example, the described communication device may be:
(1) a stand-alone integrated circuit (IC), or chip, or, chip system or subsystem;
(2) a collection having one or more ICs, Alternatively the IC collection may also include a storage component for storing data, computer programs;
(3) an ASIC, such as a modem;
(4) a module that can be embedded in other devices;
(5) a receiver, terminal device, smart terminal device, cellular phone, wireless device, handheld device, mobile unit, in-vehicle device, network device, cloud device, artificial intelligence device, and the like;
(6) others.

For the case where the communication device may be a chip or a chip system, it may refer to the schematic structure diagram of a chip shown in FIG. 9. The chip shown in FIG. 9 includes a processor 901 and an interface 902. The number of the processor 901 may be one or more, and the number of the interface 902 may be more than one.

For the case where the chip is used to realize the function of the user equipment in the embodiment of the present disclosure, the processor 901 is configured to, via the interface 902, perform step S201 in FIG. 2, step S301 in FIG. 3, and step S401 in FIG. 4.

For the case where the chip is used to realize the function of the network device in the embodiment of the present disclosure, the processor 901 is configured to perform step S501 in FIG. 5 via the interface 902, and the processor 901 is also configured to perform step S502 in FIG. 5.

Alternatively, the chip further includes a memory 903, and the memory 903 is configured to store necessary computer programs and data.

It will also be appreciated by those skilled in the art that various illustrative logical block and steps listed in the embodiments of the present disclosure may be implemented by electronic hardware, computer software, or a combination thereof. Whether such function is implemented by hardware or software depends on the particular application and the design requirement of the overall system. For each particular application, those skilled in the art may use various methods to implement the described function thereof, but such implementation should not be construed as being outside the protection scope of the present disclosure.

An embodiment of the present disclosure also provides a system for implementing joint channel estimation triggering, and the system includes the communication device as the user equipment in the above described embodiment of FIG. 6 and the communication device as the network device in the above described embodiment of FIG. 7, in some embodiments, the system includes the communication device as the user equipment and the communication device as the network device in the above described embodiment of FIG. 8.

The present disclosure further provides a readable storage medium having stored thereon instructions which, when being executed by a computer, realize the function of any of the above method embodiments.

The present disclosure also provides a computer program product that, when being executed by a computer, realizes the function of any of the above method embodiments.

The above embodiments may be implemented in whole or in part by software, hardware, firmware, or any combination thereof. When being implemented by software, the above embodiments may be implemented in whole or in part in the form of a computer program product. The computer program product includes one or more computer programs. When the computer program is loaded and executed on a computer, the process or function according to the embodiments of the present disclosure is generated in whole or in part. The computer may be a general-purpose computer, a special purpose computer, a computer network, or other programmable device. The computer program may be stored in a computer-readable storage medium or transmitted from one computer-readable storage medium to another computer-readable storage medium, e.g., the computer program may be transmitted from a web site, computer, server or data center to another web site, computer, server or data center via wired (e.g., coaxial cable, optical fiber, digital subscriber line (DSL)) or wireless (e.g., infrared, wireless, microwave, etc.) way. The computer-readable storage medium may be any usable medium which a computer can access or a data storage device such as a server, data center including one or more usable media integrated. The usable medium may be a magnetic medium (e.g., floppy disk, hard disk, tape), an optical medium (e.g., a high-density digital video disc (DVD)), a semiconductor medium (e.g., a solid state disk (SSD)), or the like.

Those skilled in the art may understand that various numerical numbering such as first, second or the like involved in the present disclosure is only for the purpose of distinguishing for the convenience of description, and is used to neither limit the scope of the embodiment of the present disclosure nor indicate the order.

The term “at least one” in the present disclosure may also be described as one or more, and the term “a plurality of” may be two, three, four, or more, which is not limited in the present disclosure. In the embodiments of the present disclosure, for a kind of technical features, “first”, “second”, “third”, “A”, “B”, “C”, “D” or the like may be used to distinguish technical features in this kind of technical features, and the description of the technical features with the “first”, “second”, “third”, “A”, “B”, “C” and “D” indicates no sequential order or size order thereof.

As used herein, the terms “machine-readable medium” and “computer-readable medium” refer to any computer program product, device, and/or apparatus (e.g., magnetic disc, optical disc, memory, programmable logic device (PLD)) that is used to provide machine instructions and/or data to a programmable processor, including a machine-readable medium that receives machine instructions as machine-readable signals. The term “machine-readable signal” refers to any signal used to provide machine instructions and/or data to a programmable processor.

The system and technique described herein may be implemented in a computing system including a back-end component (e.g., as a data server), or a computing system including a middleware component (e.g., an application server), or a computing system including a front-end components (e.g., a user's computer that has a graphical user interface or a web browser through which a user can communicate with the system and technique described herein), or in a computing system including any combination of such back-end component, middleware component, or front-end component. The components of the system may be interconnected via a digital data communication (e.g., a communication network) in any form or medium. An example of communication network includes: local area network (LAN), wide area network (WAN), and the Internet.

A computer system may include a client and a server. The client and server are generally remote from each other and typically interact over a communications network. The client-server relationship is created by computer programs that run on corresponding computers and have a client-server relationship with each other.

It should be understood that steps may be reordered, added, or deleted using various forms of processes shown above. For example, the steps recited in the present disclosure may be performed in parallel or sequentially or in a different order, as long as they can achieve the result desired by the technical solution disclosed in the present disclosure, which is not limited herein.

Furthermore, it should be understood that the various embodiments described in the present disclosure may be implemented individually or in combination with other embodiments as long as the solution permits.

Those skilled in the art may realize that the unit and algorithmic step in each example described in conjunction with the embodiments disclosed herein can be implemented in electronic hardware, or a combination of computer software and electronic hardware. Whether these functions are performed in hardware or software depends on the particular application and design constraint of the technical solution. Those skilled in the art may use different methods to implement the described function for each particular application, but such implementations should not be considered as being outside the scope of the present disclosure.

Those skilled in the art may understand that, for the convenience and brevity of the description, the specific working processes of the above-described system, device and unit may be referred to the corresponding processes in the foregoing method embodiments, which will not be repeated herein.

The above description is only a specific embodiment of the present disclosure, and the protection scope of the present disclosure is not limited thereto. Those skilled in the art may easily conceive of any changes or substitutions within the art scope disclosed by the present disclosure, and such changes and substitutions shall fall within the protection scope of the present disclosure. Therefore, the protection scope of the present disclosure shall be subject to the protection scope of the stated claims.

1. A triggering method for joint channel estimation, applied to a user equipment (UE) and comprising:
sending a message related to the joint channel estimation to a network device, so that the network device determines whether to perform the joint channel estimation based on the message.

2. The triggering method according to claim 1, wherein the UE non-periodically sends the message to the network device to trigger the network device to perform the joint channel estimation in response to determining that the UE meets a predetermined condition for the joint channel estimation.

3. The triggering method according to claim 1, wherein the UE periodically sends the message to the network device.

4. The triggering method according to claim 1, wherein the message comprises at least one of following information:
information indicating whether the UE meets a predetermined condition for the joint channel estimation; or
information indicating a time window in which the UE meets the predetermined condition.

5. The triggering method according to claim 1, wherein the message is any one of following messages:
a UE-specific message;
a UE group-specific message, wherein all UEs belonging to a same UE group share the UE group-specific message; or
a cell-specific message, wherein all-UEs located within a same cell share the cell-specific message.

6. The triggering method according to claim 1, wherein sending the message related to the joint channel estimation to the network device comprises:
sending the message to the network device in an explicit manner,
wherein the explicit manner comprises at least one of following acts: sending the message via additional dedicated signaling configured for representing the message, or sending the message via existing uplink signaling comprising an additional item configured for representing the message.

7. (canceled)

8. The triggering method according to claim 1, wherein sending the message related to the joint channel estimation to the network device comprises:
sending the message to the network device in an implicit manner,
wherein the implicit manner comprises at least one of following acts: sending the message by mapping the message to a specified item of specified uplink signaling according to a predetermined operation, sending the message by binding a specific resource block according to a pre-configured mapping relationship, or sending the message by multiplexing an existing domain and sending a multiplexing indicator.

9-10. (canceled)

11. A triggering method for joint channel estimation, applied to a network device and comprising:
receiving a message related to the joint channel estimation; and
determining, based on the message, whether to perform the joint channel estimation.

12. The triggering method according to claim 11, wherein determining, based on the message, whether to perform the joint channel estimation comprises:
performing the joint channel estimation in response to determining that the message indicates that a user equipment (UE) meets a predetermined condition for the joint channel estimation.

13. The triggering method according to claim 11, wherein the message comprises at least one of following information:
information indicating whether a UE meets a predetermined condition for the joint channel estimation; or
information indicating a time window in which the UE meets the predetermined condition.

14. The triggering method according to claim 11, wherein the message is any one of following messages:
a UE-specific message;
a UE group-specific message, wherein all UEs belonging to a same UE group share the UE group-specific message; or
a cell-specific message, wherein all UEs located within a same cell share the cell-specific message.

15-18. (canceled)

19. A non-transitory computer-readable storage medium having computer-executable instructions stored thereon that, when being executed by a processor, cause the processor to perform acts according to claim 1.

20. (canceled)

21. A user equipment (UE), comprising:
a processor; and
a memory, having executable instructions stored thereon that, when being executed by the processor, cause the processor to perform operations comprising:
sending a message related to the joint channel estimation to a network device, so that the network device determines whether to perform the joint channel estimation based on the message.

22. The UE according to claim 21, wherein the UE non-periodically sends the message to the network device to trigger the network device to perform the joint channel estimation in response to determining that the UE meets a predetermined condition for the joint channel estimation.

23. The UE according to claim 21, wherein the UE periodically sends the message to the network device.

24. The UE according to claim 21, wherein the message comprises at least one of following information:
information indicating whether the UE meets a predetermined condition for the joint channel estimation; or
information indicating a time window in which the UE meets the predetermined condition.

25. The UE according to claim 21, wherein the message is any one of following messages:
a UE-specific message;
a UE group-specific message, wherein all UEs belonging to a same UE group share the UE group-specific message; or
a cell-specific message, wherein all UEs located within a same cell share the cell-specific message.

26. The UE according to claim 21, wherein the operations further comprise:
sending the message to the network device in an explicit manner,
wherein the explicit manner comprises at least one of following acts: sending the message via additional dedicated signaling configured for representing the message, or sending the message via existing uplink signaling comprising an additional item configured for representing the message.

27. The UE according to claim 21, wherein the operations further comprise:
sending the message to the network device in an implicit manner,
wherein the implicit manner comprises at least one of following acts: sending the message by mapping the message to a specified item of specified uplink signaling according to a predetermined operation, sending the message by binding a specific resource block according to a pre-configured mapping relationship, or sending the message by multiplexing an existing domain and sending a multiplexing indicator.

28. A network device, comprising:
a processor; and
a memory, having executable instructions stored thereon that, when being executed by the processor, cause the processor to perform acts according to claim 11.
